(19) United States
(12) Patent Application Publication
(10) Pub. No.: US 2013/0052578 A1
(43) Pub. Date: Feb. 28, 2013

(54) TONER FOR ELECTROSTATIC LATENT IMAGE DEVELOPMENT

(71) Applicant: Masanori Sugahara, Osaka (JP)

(72) Inventor: Masanori Sugahara, Osaka (JP)

(73) Assignee: KYOCERA DOCUMENT SOLUTIONS INC., Osaka (JP)

(21) Appl. No.: 13/596,674

(22) Filed: Aug. 28, 2012

(30) Foreign Application Priority Data
Aug. 31, 2011 (JP) 2011-188616

(51) Int. Cl. G03G 9/16

(52) U.S. Cl. 430/108.4

(57) ABSTRACT

A toner for electrostatic latent image development includes at least a binder resin, a colorant, a charge control agent, and a release agent. The release agent contains a synthetic ester wax and a natural ester wax. When a toner sample is measured by a differential scanning calorimeter in a way that the toner sample is heated from 30° C. to 170° C. at a rate of 10° C./min followed by cooling to 30° C. at a rate of 10° C./min and is then re-heated from 30° C. to 170° C. at a rate of 10° C./min, a fusion-starting temperature TB, a lower endothermic peak temperature T1 derived from one ester wax, an intermediate endothermic peak temperature T2, and a higher endothermic peak temperature T3 derived from another ester wax are respectively a certain temperature, and are observed during the re-heating.

### INCORPORATION BY REFERENCE

This application is based upon and claims the benefit of priority from the corresponding Japanese Patent Application No. 2011-188616, filed in the Japan Patent Office on Aug. 31, 2011, the entire contents of which are incorporated herein by reference.

### FIELD

The present disclosure relates to a toner for electrostatic latent image development.

### BACKGROUND

In electrophotography, generally, a surface of an electrostatic latent image carrier (photoconductor) is uniformly charged by corona discharge etc. in advance, and then the uniformly charged surface of the electrostatic latent image carrier is exposed to laser etc. to form an electrostatic latent image. Then, the electrostatic latent image is developed by a toner to form a toner image on the surface of the electrostatic latent image carrier, and the toner image is further transferred on a recording medium to obtain an image with high quality. The toner used for forming toner images is typically one produced by mixing a binder resin such as thermoplastic resin with a colorant, a charge control agent, a release agent, a magnetic material, and the like, then the mixture is further mixed and kneaded, pulverized, and classified to form toner particles (toner base particles) with an average particle diameter of 5 to 10 μm. In order to provide flowability to the toner, to impart a proper charging property to the toner, and to improve cleaning ability of the toner not transferred and remaining on the photoconductor, inorganic fine particles such as silica and titanium oxide are externally added to the toner.

Such a toner is required to be excellent in low-temperature fixability so as to allow proper fixture even without heating fixing rollers as possible from the viewpoint of energy saving, downsizing of apparatuses, etc. However, binder resins with a lower melting point and a lower glass transition point and/or release agents with a lower melting point are often used in such a toner excellent in low-temperature fixability. For this reason, generally, when the toner excellent in low-temperature fixability is used, agglomeration tends to be caused during storage thereof at higher temperatures and hot offset is likely to occur because of fusion of the toner to heated fixing rollers.

In order to solve these problems, various investigations have been carried out. For example, there is a wax composition, used for a release agent of a toner, that contains a wax with lower melting point and a wax with higher melting point as main components, in which when measured by a differential scanning calorimeter (DSC) at a second temperature-increasing period, the component of the wax with lower melting point has a maximum endothermic peak P1 between 60° C. and 90° C., the component of the wax with higher melting point has a maximum endothermic peak P2 between 100° C. and 150° C., and the difference from the peak temperature P2 to the peak temperature P1 is 20° C. or more.

When such a wax composition is used for a release agent, surely, a toner excellent in low-temperature fixability and hot offset resistance may be easily obtained. However, the toner obtained using the wax composition tends to agglomerate during storage at high temperatures and to degrade heat-resistant storage stability due to an effect of the component of the wax with lower melting point. Furthermore, there may be a problem in the toner obtained using the wax composition in that the wax is resistant to be properly dispersed in the binder resin and glossiness of images formed using the toner tends to be lowered depending on a combination of the wax with lower melting point and the wax with high melting point.

The present disclosure has been made in view of the problems described above; and it is an object of the present disclosure to provide a toner for electrostatic latent image development that is excellent in low-temperature fixability, storage stability, and hot offset resistance and allows forming images with excellent glossiness.

### SUMMARY

The present disclosure relates to a toner for electrostatic latent image development that includes at least a binder resin, a colorant, a charge control agent, and a release agent. The release agent contains a synthetic ester wax and a natural ester wax. When a toner sample is measured by a differential scanning calorimeter in a way that the toner sample is heated from 30° C. to 170° C. at a rate of 10° C./min followed by cooling to 30° C. at a rate of 10° C./min and is then re-heated from 30° C. to 170° C. at a rate of 10° C./min, a fusion-starting temperature TB is 60° C. or higher, a lower endothermic peak temperature T1 derived from one ester wax is 63° C. to 73° C., an intermediate endothermic peak temperature T2 is 73° C. to 80° C., and a higher endothermic peak temperature T3 derived from another ester wax is 80° C. to 87° C., and the TB, the T1, the T2 and the T3 are observed during the re-heating.

### BRIEF DESCRIPTION OF THE DRAWINGS

FIG. 1 is a chart of differential scanning calorimetry analysis of the toner of Example 1.

### DETAILED DESCRIPTION OF EMBODIMENTS

The present disclosure is explained in detail with respect to embodiments below; however, the present disclosure is not limited at all to the embodiments below and may be carried out with appropriately making a change within the purpose of the present disclosure. In addition, explanation may be occasionally omitted with respect to duplicated matters; this does not however limit the gist of the present disclosure.

The toner for electrostatic latent image development (hereinafter also referred to as “toner”) includes at least a colorant, a charge control agent, and a release agent in a binder resin. The release agent, included in the toner, contains a synthetic ester wax and a natural ester wax. When a toner sample is measured by a differential scanning calorimeter in a way that the toner sample is heated from 30° C. to 170° C. at a rate of 10° C./min followed by cooling to 30° C. at a rate of 10° C./min and is then re-heated from 30° C. to 170° C. at a rate of 10° C./min, a fusion-starting temperature TB, a lower endothermic peak temperature T1 derived from one ester wax, an intermediate endothermic peak temperature T2, and a higher endothermic peak temperature T3 derived from another ester wax are respectively within a certain temperature range, and are observed during the re-heating.

The toner for electrostatic latent image development of the present disclosure may include a magnetic powder in addition to the binder resin, the colorant, the charge control agent, and the release agent. In regards to the toner for electrostatic latent image development, an external additive may also be attached to a surface of toner base particles which have been prepared by melting and kneading the binder resin and various other components followed by pulverizing thereof. Furthermore, the toner of the present disclosure may be mixed with a carrier and used for a two-component developer as required. Hereinafter, the toner for electrostatic latent image development of the present disclosure is explained with respect to the binder resin, the colorant, the release agent, the charge control agent, the magnetic powder, the external additive, and the carrier used in a case of employing the toner of the present disclosure as a two-component developer, and also a method of producing the toner for electrostatic latent image development of the present disclosure in order.

### [Binder Resin]

The binder resin, included in the toner of the present disclosure, is not particularly limited within a range that does not inhibit the purpose of the present disclosure and may be properly selected from conventional resins used heretofore for binder resins for toners considering properties such as melting point, glass transition point, and softening point thereof. Specific examples of the binder resin include thermoplastic resins such as styrene resins, acrylic resins, styrene-acrylic resins, polyethylene resins, polypropylene resins, vinyl chloride resins, polyester resins, polyamide resins, polyurethane resins, polyvinyl alcohol resins, vinyl ether resins, N-vinyl resins, and styrene-butadiene resins. Among these resins, styrene-acrylic resins and polyester resins are preferable in view of dispersibility of colorants in the toner, chargeability of the toner, and fixability of the toner to paper. Hereinafter, the styrene-acrylic resin and polyester resin are explained.

The styrene-acrylic resin is a copolymer of a styrene monomer and an acrylic monomer. Specific examples of the styrene monomer include styrene, α-methylstyrene, vinyl toluene, α-chlorostyrene, o-chlorostyrene, m-chlorostyrene, p-chlorostyrene, and p-ethylstyrene. Specific examples of the acrylic monomer include alkyl(meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

The polyester resin may be those resulting from condensation polymerization or condensation copolymerization of an alcohol component and a carboxylic acid component. The components used for synthesizing polyester resins are exemplified by bivalent, trivalent or higher-valent alcohol components and bivalent, trivalent or higher-valent carboxylic acid components below.

Specific examples of the bivalent, trivalent or higher-valent alcohols include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol, and polytetramethylene glycol; bisphenols such as bisphenol A, hydrogen added bisphenol A, polyoxyethylenizied bisphenol A, and polyoxypropylenized bisphenol A; and trivalent or higher-valent alcohols such as sorbitol, 1,2,3,6-hexane tetrol, 1,4-sorbitane, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of the bivalent, trivalent or higher-valent carboxylic acids include bivalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azealic acid, and malonic acid, or alkyl or alkenyl succinic acids including n-butyl succinic acid, n-butenyl succinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid, isododecenylsuccinic acid; and trivalent or higher-valent carboxylic acids such as 1,2,4-benzene tricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxypropane, 1,2,4-cyclohexane tricarboxylic acid, tetra(methylenecarboxyl)methane, 1,2,7,8-octanetetracarboxylic acid, pyromellitic acid, and Enpol trimer. These bivalent, trivalent or higher-valent carboxylic acids may be used as ester-forming derivatives such as an acid halide, an acid anhydride, and a lower alkyl ester. The term “lower alkyl” means an alkyl group of 1 to 6 carbon atoms.

When the binder resin is a polyester resin, the softening point of the polyester resin is preferably 100° C. to 130° C. and more preferably 100° C. to 120° C. When the softening point of the polyester resin is within this range, the toner excellent in low-temperature fixability may be easily obtained.

A thermoplastic resin is preferably used for the binder resin since the toner with proper fixability to paper may be easily obtained; here, the thermoplastic resin may be added with a cross-linking agent or a thermosetting resin rather than solely using the thermoplastic resin. By way of introducing a partial cross-linked structure into the binder resin, properties of the toner such as storage stability, morphological retention, and durability may be improved without degrading fixability of the toner to paper.

Preferable examples of the thermosetting resin usable in combination with the thermoplastic resin are epoxy resins and cyanate resins. Specific examples of the preferable thermosetting resin include bisphenol-A type epoxy resins, hydrogenated bisphenol-A type epoxy resins, novolac-type epoxy resins, polyalkylene ether-type epoxy resins, cyclic aliphatic-type epoxy resins, and cyanate resins. These thermosetting resins may be used in a combination of two or more.

The glass transition point (Tg) of the binder resin is preferably 50° C. to 65° C. and more preferably 50° C. to 60° C. When the glass transition point of the binder resin is excessively low, the toner itself may agglomerate within developing units of image forming apparatuses, or the toner itself may partially agglomerate during shipping in toner containers or storage in warehouses due to degradation of storage stability. Furthermore, when the glass transition point is excessively high, the toner is likely to adhere to latent image carrier units (image carrier or photoconductor) due to a lower strength of the binder resin. When the glass transition point is excessively high, the fixability of the toner tends to degrade at lower temperatures.

Additionally, the glass transition point of the binder resin can be determined from a changing point of specific heat of the binder resin using a differential scanning calorimeter (DSC). More specifically, the glass transition point of the binder resin can be determined by measuring an endothermic curve using a differential scanning calorimeter (DSC-6200, by Seiko Instruments Inc.) as a measuring device. Ten mg of a sample to be measured is put into an aluminum pan and an empty aluminum pan is used as a reference. An endothermic curve is measured under the conditions of a measuring temperature range of 25° C. to 200° C., a temperature-increase rate of 10° C./min, under normal temperature and normal humidity, then the glass transition point can be determined from the resulting endothermic curve.

### [Colorant]

The toner for electrostatic latent image development of the present disclosure contains a colorant in the binder resin. The colorant contained in the toner may be appropriately selected from conventional pigments and dyes depending on color of the toner particles. Specific examples of appropriate colorants added to the toner include black pigments such as carbon black, acetylene black, lamp black, and aniline black; yellow pigments such as chrome yellow, zinc yellow, cadmium yellow, yellow iron oxide, mineral fast yellow, nickel titanium yellow, nables yellow, naphthol yellow S, hanza yellow G, hanza yellow 10G, benzizin yellow G, benzizin yellow GR, quinoline yellow lake, permanent yellow NCG, and turtrazin lake; orange pigments such as red chrome yellow, molybdenum orange, permanent orange GTR, pyrazolone orange, balcan orange, and indanthrene brilliant orange GK; red pigments such as iron oxide red, cadmium red, minium, cadmium mercury sulfate, permanent red 4R, lisol red, pyrazolone red, watching red calcium salt, lake red D, brilliant carmine 6B, eosine lake, rhodamine lake B, alizarin lake, and brilliant carmine 3B; violet pigments such as manganese violet, fast violet B, and methyl violet lake; blue pigments such as pigment blue 27, cobalt blue, alkali blue lake, Victoria blue partially chlorinated product, fast sky blue, and indanthrene blue BC; green pigments such as chrome green, chromium oxide, pigment green B, malachite green lake, and final yellow green G; white pigments such as zinc white, titanium dioxide, antimony white, and zinc sulfate; and extender pigments such as baryta powder, barium carbonate, clay, silica, white carbon, talc, and alumina white. These colorants may be used in a combination of two or more for the purpose of tailoring the toner to a intended hue.

The amount of the colorant used is not particularly limited within a range that does not inhibit the purpose of the present disclosure. Specifically, the amount of the colorant used is preferably 1 to 10 parts by mass and more preferably 3 to 7 parts by mass based on 100 parts by mass of the binder resin.

### [Release Agent]

The release agent is a component which is used for the purpose of improving fixability to paper and offset resistance of the toner. The toner for electrostatic latent image development of the present disclosure essentially contains the release agent. The release agent in the toner for electrostatic latent image development of the present disclosure contains a synthetic ester wax and a natural ester wax. Typically, the total content of the synthetic ester wax and the natural ester wax in the release agent, which is not particularly limited within a range that does not inhibit the purpose of the present disclosure, is preferably 80% by mass or more, more preferably 90% by mass or more, and most preferably 100% by mass.

The toner for electrostatic latent image development of the present disclosure contains the synthetic ester wax and the natural ester wax as the release agent. For this reason, when the toner is analyzed using the differential scanning calorimeter (DSC) by a predetermined process described later, an lower-temperature endothermic peak derived from a wax with lower melting point, a higher-temperature endothermic peak derived from a wax with higher melting point, and an intermediate endothermic peak existing between the lower-temperature endothermic peak and the higher-temperature endothermic peak are observed. The toner of the present disclosure has such an endothermic property. For this reason, the toner of the present disclosure is excellent in low-temperature fixability, storage stability, and hot offset resistance and allows forming images with excellent glossiness.

The melting point of the wax with lower melting point in the release agent is preferably 60° C. to 75° C. and more preferably 65° C. to 75° C. Furthermore, the melting point of the wax with higher melting point in the release agent is preferably 75° C. to 95° C. and more preferably 80° C. to 90° C. When the waxes with these melting points are used in combination, the toner with an intended endothermic pattern in the DSC measurement may be easily prepared.

It is considered that when the synthetic ester wax and the natural ester wax are mixed, the intermediate endothermic peak occurs while maintaining the lower-temperature endothermic peak and the higher-temperature endothermic peak because of the synthetic ester wax and the natural ester wax being each an ester wax and thus highly compatible each other as well as the effect of a slight amount of impurities such as fatty acids, aliphatic alcohols, or structure-unknown constituents in the natural ester wax. Either melting point among the melting points of the synthetic ester wax and the natural ester wax may be higher than the other. The combination of the synthetic ester wax as the wax with lower melting point and the natural ester wax as the wax with higher melting point is preferable among combinations of the waxes. The reason is that the melting point of the synthetic ester wax may be more easily adjusted than that of the natural ester wax and thus the synthetic ester wax with lower melting point may be more easily obtained.

When the combination of waxes is of natural ester waxes themselves or synthetic ester waxes themselves, the lower-temperature endothermic peak and the higher-temperature endothermic peak are extinguished, and only the intermediate endothermic peak is observed. Additionally, when the synthetic ester wax is substituted with a paraffin wax with no ester group, only the lower-temperature endothermic peak and the higher-temperature endothermic peak are observed and thus the intermediate endothermic peak is not observed.

When the toner of the present disclosure is measured by the differential scanning calorimeter in accordance with the process shown below, the fusion-starting temperature TB observed during the re-heating is 60° C. or higher, the lower endothermic peak temperature T1 derived from one ester wax is 63° C. to 73° C., the intermediate endothermic peak temperature T2 is 73° C. to 80° C., and the higher endothermic peak temperature T3 derived from another ester wax is 80° C. to 87° C. Hereinafter, the process of measuring the fusion-starting temperature TB, the lower endothermic peak temperature T1, the intermediate endothermic peak temperature T2, and the higher endothermic peak temperature T3 by the differential scanning calorimeter is explained.

Measuring Method by Differential Scanning calorimeter

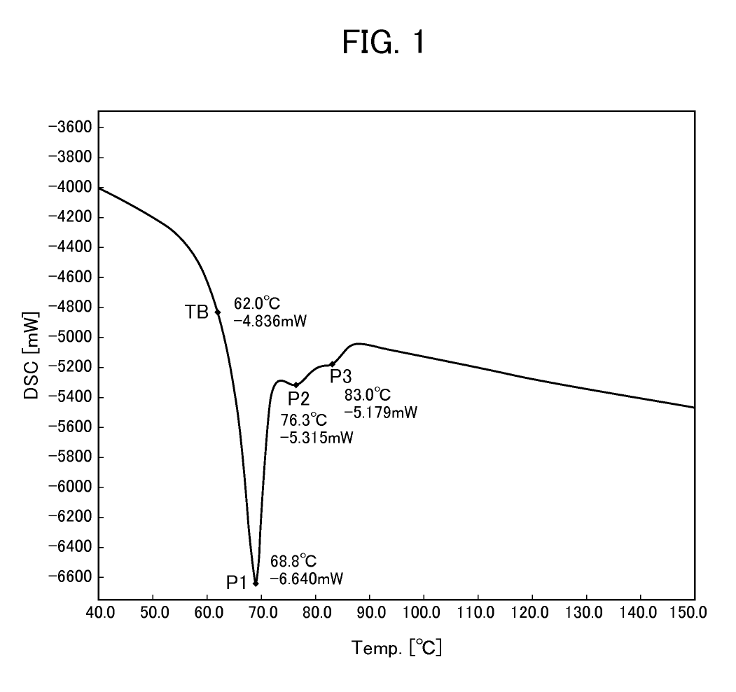

DSC6200 (by Seiko Instruments Inc.) is used as the differential scanning calorimeter (DSC). A toner sample is heated from 30° C. to 170° C. at a rate of 10° C./min. Then, the toner sample is cooled to 30° C. at a rate of 10° C./min. In addition, the toner sample is re-heated from 30° C. to 170° C. at a rate of 10° C./min, thereby measurement is performed by the differential scanning calorimeter. Here, amount of the toner sample is 10 mg. Based on a DSC curve of the toner resulting from measurement at the time of re-heating, TB, T1, T2, and T3 are determined. Initially, a temperature at an intersection between a base line observed at the side higher than the higher endothermic peak temperature T3 and a downward curve observed at the side lower than the lower endothermic peak temperature T1 is determined as TB (° C.) (see FIG. 1). Next, three peak temperatures observed in series after starting the measurement are determined as T1 (° C.), T2 (° C.), and T3 (° C.) from the side of lower peak temperature.

The fusion-starting temperature TB and the lower endothermic peak temperature T1 can be controlled by adjusting a melting point of the wax with lower melting point among the two waxes. Furthermore, the higher endothermic peak temperature T3 can be controlled by adjusting a melting point of the wax with higher melting point among the two waxes. Still further, the intermediate endothermic peak temperature T2 can be controlled by adjusting the melting points of the two waxes respectively. That is, when the melting point of the wax with lower melting point among the two waxes is lowered, T2 is lowered; and when the melting point of the wax with lower melting point is raised, T2 is raised. Furthermore, when the melting point of the wax with higher melting point among the two waxes is lowered, T2 is lowered; and when the melting point of the wax with higher melting point is raised, T2 is raised.

### (Natural Ester Wax)

The natural ester wax usable in the toner of the present disclosure is ester waxes obtainable from plant materials. Specific examples of the natural ester waxes may be exemplified by candelilla wax, carnauba wax, rice wax, vegetable wax, and jojoba wax. Among these natural ester waxes, carnauba wax or rice wax is more preferable. The melting point of the natural ester wax may be appropriately selected considering the melting point of the synthetic ester wax and an endothermic pattern in the DSC measurement of the resulting toner.

### (Synthetic Ester Wax)

The synthetic ester wax usable for the toner of the present disclosure may be commercially available synthetic ones or those synthesized from desired raw materials (e.g., fatty acids, aliphatic alcohols). Specific examples of preferably usable synthetic ester waxes may be exemplified by commercially available ones such as WEP-4 (melting point 71° C., by NOF Co.), WEP-2 (melting point 71° C., by NOF Co.), WEP-6 (melting point 80° C., by NOF Co.), and WEP-8 (melting point 79° C., by NOF Co.). The melting point of the synthetic ester wax may be appropriately selected considering the melting point of the natural ester wax and an endothermic pattern in the DSC measurement of the resulting toner.

The content ratio of the natural ester wax to the synthetic ester wax in the release agent is not particularly limited within a range that does not inhibit the purpose of the present disclosure. The content ratio of the natural ester wax to the synthetic ester wax, expressed as (natural ester wax)/(synthetic ester wax), is preferably 3/7 to 7/3 and more preferably 4/6 to 6/4.

When the value of (natural ester wax)/(synthetic ester wax) is excessively large or excessively small, the content of the wax with lower melting point is excessively small or the content of the wax with higher melting point is excessively small. When the content of the wax with lower melting point is excessively small, low-temperature fixability of the toner tends to degrade. Furthermore, when the content of the wax with higher melting point is excessively small, heat-resistant storage stability of the toner tends to degrade since the content of the wax with lower melting point is larger. Additionally, when the wax with lower melting point is dispersed into the binder resin through melting and kneading, it is difficult to apply a shear force to the wax with lower melting point since viscosity of the wax becomes excessively low. Therefore, when the content of the wax with higher melting point is excessively small, it is difficult to properly disperse the wax into the binder resin when producing the toner since the content of the wax with lower melting point is larger. When forming an image using such a toner, glossiness of the resulting image tends to decrease. Additionally, when the content of the wax with higher melting point is excessively small, heat-resistant storage stability of the toner tends to degrade.

The amount of the release agent used is not particularly limited within a range that does not inhibit the purpose of the present disclosure. The specific amount of the release agent used is preferably 1 to 5 parts by mass based on 100 parts by mass of the binder resin. When the amount of the release agent used is excessively small, a desired effect may not be obtained to suppress occurrences of offset or image smearing; and when the amount of the release agent used is excessively large, storage stability may be deteriorated due to fusion of the toner itself.

### [Charge Control Agent]

The toner for electrostatic latent image development of the present disclosure contains a charge control agent. The charge control agent is used for the purpose of improving a charged level of the toner or a charge-increasing property, which is an indicator of chargeability to a predetermined charged level within a short time, thereby obtaining a toner with excellent durability and stability. When development is performed by positively charging the toner, a positively-chargeable charge control agent is used; and when development is performed by negatively charging the toner, a negatively-chargeable charge control agent is used.

The type of the charge control agent, which is not particularly limited within a range that does not inhibit the purpose of the present disclosure, may be appropriately selected from conventional charge control agents used for toners heretofore. Specific examples of the positively-chargeable charge control agent are azine compounds such as pyridazine, pyrimidine, pyrazine, ortho-oxazine, meta-oxazine, para-oxazine, ortho-thazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes consisting of azine compounds such as azine FastRed FC, azine FastRed 12BK, azine Violet BO, azine Brown 3G, azine Light Brown GR, azine Dark Green BH/C, azine Deep Black EW, and azine Deep Black 3RL; nigrosine compounds such as nigrosine, nigrosine salts, and nigrosine derivatives; acid dyes consisting of nigrosine compounds such as nigrosine BK, nigrosine NB, and nigrosine Z; metal salts of naphthenic acid or higher fatty acid; alkoxylated amine; alkylamido; quaternary ammonium salts such as benzylmethylhexyldecyl ammonium, and decyltrimethylammonium chloride; and the like. Among these positively-chargeable charge control agents, nigrosine compounds are particularly preferable since a more rapid charge-increasing property may be obtained. These positively-chargeable charge control agents may be used in a combination of two or more.

In addition, resins having a quaternary ammonium salt, a carboxylic acid salt, or a carboxyl group as a functional group may be used for the positively-chargeable charge control agent. More specifically, styrene resins having a quaternary ammonium salt, acrylic resins having a quaternary ammonium salt, styrene-acrylic resins having a quaternary ammonium salt, polyester resins having a quaternary ammonium salt, styrene resins having a carboxylic acid salt, acrylic resins having a carboxylic acid salt, styrene-acrylic resins having a carboxylic acid salt, polyester resins having a carboxylic acid salt, styrene resins having a carboxylic group, acrylic resins having a carboxylic group, styrene-acrylic resins having a carboxylic group, and polyester resins having a carboxylic group may be exemplified. Molecular weight of these resins is not particularly limited within a range that does not inhibit the purpose of the present disclosure; and oligomers or polymers may also be allowable.

Among the resins usable as the positively-chargeable charge control agent, styrene-acrylic resins having a quaternary ammonium salt as the functional group are more preferable since the charged amount may be easily controlled within an intended range. In regards to the styrene-acrylic resins having a quaternary ammonium salt as the functional group, specific examples of acrylic comonomers preferably copolymerized with a styrene unit may be exemplified by (meth)acrylic acid alkyl esters such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Additionally, the units derived from dialkylamino alkyl(meth)acrylates, dialkyl(meth)acrylamides, or dialkylamino alkyl(meth)acrylamides through a quaternizing step may be used as the quaternary ammonium salt. Specific examples of dialkylamino alkyl(meth)acrylate include dimethylamino ethyl(meth)acrylate, diethylamino ethyl(meth)acrylate, dipropylamino ethyl(meth)acrylate, and dibutylamino ethyl(meth)acrylate. A specific example of dialkyl(meth)acrylamide is dimethyl methacrylamide. A specific example of dialkylamino alkyl(meth)acrylamide is dimethylamino propylmethacrylamide. Additionally, hydroxyl group-containing polymerizable monomers such as hydroxy ethyl(meth)acrylate, hydroxy propyl(meth)acrylate, 2-hydroxy butyl(meth)acrylate, and N-methylol (meth)acrylamide may be used in combination at the time of polymerization.

Specific examples of the negatively-chargeable charge control agent are organic metal complexes and chelate compounds. The organic metal complex and the chelate compound are preferably acetylacetone metal complexes such as aluminum acetylacetonate and iron(II) acetylacetonate, salicylic acid metal complexes such as chromium 3,5-di(tert-butyl)salicylate, or salicylic acid metal salts, and more preferably salicylic acid metal complexes or salicylic acid metal salts. These negatively-chargeable charge control agents may be used in a combination of two or more.

The amount of the positively- or negatively-chargeable charge control agent used is not particularly limited within a range that does not inhibit the purpose of the present disclosure. The amount of the positively- or negatively-chargeable charge control agent used is typically 1.5 to 15 parts by mass based on 100 parts by mass of the total amount of the toner, more preferably 2.0 to 8.0 parts by mass, and particularly preferably 3.0 to 7.0 parts by mass. When the amount of the charge control agent used is excessively small, image density of the resulting images may be lower than a desired value or it may become difficult to maintain image density of the resulting images for a long period since it is difficult to stably charge the toner in a predetermined polarity. Furthermore, in such a case, the charge control agent becomes resistant to be uniformly dispersed, thus fog tends to occur in the resulting images or smear due to toner components tends to occur in latent image carrier units. When the amount of the charge control agent used is excessively large, image defects caused by an inferior charge under high temperature and high humidity due to degradation of environmental resistance tend to occur in the resulting images or smear etc. of toner components tends to occur in latent image carrier units.

### [Magnetic Powder]

In the toner for electrostatic latent image development of the present disclosure, a magnetic powder may be compounded in the binder resin. The type of the magnetic powder compounded in the toner is not particularly limited within a range that does not inhibit the purpose of the present disclosure. Specific examples of the preferable magnetic powder include iron oxides such as ferrite and magnetite, ferromagnetic metals such as of cobalt and nickel, alloys of iron and/or ferromagnetic metals, compounds of iron and/or ferromagnetic metals, ferromagnetic alloys via ferromagnetizing treatment like heat-treatment, and chromium dioxide.

Particle diameter of the magnetic powder is not particularly limited within a range that does not inhibit the purpose of the present disclosure. Specifically, the particle diameter of the magnetic powder is preferably 0.1 to 1.0 μm and more preferably 0.1 to 0.5 μm. The magnetic powder within this range of particle diameter may be easily dispersed into the binder resin.

In order to improve dispersibility of the magnetic powder into the binder resin, for example, those surface-treated by a surface treatment agent such as a titanium coupling agent and a silane coupling agent may be used.

The amount of the magnetic powder used is not particularly limited within a range that does not inhibit the purpose of the present disclosure. In a case that the toner is used as a one-component developer, the specific amount of the magnetic powder used is preferably 35 to 60 parts by mass and more preferably 40 to 60 parts by mass based on 100 parts by mass of the total amount of the toner. When the amount of the magnetic powder used is excessively large, image density of the resulting images may be lower than a desired value in a case of printing for a long period or fixability of the toner to paper may be extremely deteriorated. When the amount of the magnetic powder used is excessively small, fog tends to occur in the resulting images or image density may be lower than a desired value in a case of printing for a long period. Additionally, in a case that the toner is used as a two-component developer, the amount of the magnetic powder used is preferably 20% by mass or less and more preferably 15% by mass or less based on 100 parts by mass of the total amount of the toner.

### [External Additive]

In the toner for electrostatic latent image development of the present disclosure, an external additive may be attached to a surface of the toner base particles in order to improve properties of the toner such as flowability, storage stability, cleaning ability. In addition, particles to be treated for attaching an external additive are referred to as “toner base particles” in this specification and within the scope of claims of the present application.

The type of the external additive, which is not particularly limited within a range that does not inhibit the purpose of the present disclosure, and the external additive may be appropriately selected from those conventionally used for toners. Specific examples of the external additive include silica and metal oxides such as alumina, titanium oxide, magnesium oxide, zinc oxide, strontium titanate, and barium titanate. These external additives may be used in a combination of two or more.

The particle diameter of the external additive is not particularly limited within a range that does not inhibit the purpose of the present disclosure; typically, the range of 0.01 to 1.0 μm is preferable.

The value of volume specific resistance of the external additive may be adjusted by forming a coating layer consisting of tin oxide and antimony oxide on the surface of the external additive and changing a thickness of the coating layer or a ratio of tin oxide to antimony oxide.

The amount of the external additive used to the toner base particles is not particularly limited provided that it is within a range that does not inhibit the purpose of the present disclosure. Typically, the amount of the external additive used is preferably 0.1 to 10 parts by mass and more preferably 0.2 to 5 parts by mass based on 100 parts by mass of the toner base particles. When the external additive is used within this range, the toner excellent in flowability, storage stability, and cleaning ability may be easily obtained.

### [Carrier]

The toner for electrostatic latent image development of the present disclosure may be mixed with a desired carrier and used as a two-component developer. In a case of preparing the two-component developer, a magnetic carrier is preferably used.

A carrier, of which core material is coated with a resin, is exemplified as a usable carrier in the case of using the toner for electrostatic latent image development of the present disclosure for the two-component developer. Specific examples of the material of carrier core are particles of iron, oxidized iron, reduced iron, magnetite, copper, silicon steel, ferrite, nickel, and cobalt; alloy particles of these materials and manganese, zinc, aluminum, etc.; alloy particles of iron-nickel alloy, iron-cobalt alloy, etc.; ceramic particles of titanium oxide, aluminum oxide, copper oxide, magnesium oxide, lead oxide, zirconium oxide, silicon carbide, magnesium titanate, barium titanate, lithium titanate, lead titanate, lead zirconate, lithium niobate, etc.; particles of higher permittivity materials such as sodium dihydrogen phosphate, potassium dihydrogen phosphate, and Rochelle salts; resin carriers dispersing these magnetic particles into resins; and the like.

Specific examples of the resin, which coats the core material of carrier, include (meth)acrylic polymers, styrene polymers, styrene-(meth)acrylic polymers, olefin polymers (polyethylene, chlorinated polyethylene, polypropylene, etc.), polyvinyl chloride, polyvinyl acetate, polycarbonate, cellulose resins, polyester resins, unsaturated polyester resins, polyamide resins, polyurethane resins, epoxy resins, silicone resins, fluorocarbon resins (polytetrafluoroethylene, polychlorotrifluoroethylene, polyvinylidene fluoride, etc.), phenol resins, xylene resins, diallyl phthalate resins, polyacetal resins, amino resins, etc. These resins may be used in a combination of two or more.

The particle diameter of the carrier, which is not particularly limited within a range that does not inhibit the purpose of the present disclosure, is preferably 20 to 120 μm and more preferably 25 to 80 μm as a particle diameter measured by an electron microscope.

The apparent density of the carrier is not particularly limited within a range that does not inhibit the purpose of the present disclosure. Typically, the apparent density of the carrier, which depends on a carrier composition and surface structure, is preferably 2.0 to 2.5 g/cm³.

When the toner for electrostatic latent image development of the present disclosure is used as the two-component developer, the content of the toner is preferably 1% to 20% by mass and more preferably 3% to 15% by mass based on the mass of the two-component developer. By adjusting the content of the toner in the two-component developer within the range, an appropriate image density may be maintained, and pollution inside image forming apparatuses and adhesion of the toner to recorded media such as transfer paper may be suppressed because of inhibiting scattering of the toner from development units.

### [Method of Producing Toner for Electrostatic Latent Image Development]

In the method of producing the toner for electrostatic latent image development of the present disclosure, the binder resin is compounded with the colorant, the charge control agent, the release agent, and optional components such as magnetic powder if necessary, then preparing toner base particles with a desired particle diameter. The production may further include attaching the external additive to the surface of the toner base particles as required.

The method of producing the toner base particles by compounding the binder resin with the colorant, the charge control agent, the release agent, and optional components such as the magnetic powder if necessary is not particularly limited as long as these components can be properly dispersed into the binder resin. A specific example of desirable method of producing the toner base particles may be such that the binder resin and components including the colorant, the release agent, the charge control agent, and the magnetic powder are mixed by a mixer, etc., then the binder resin and the components to be compounded with the binder resin are melted and kneaded by a kneading machine such as a single or twin screw extruder, and the kneaded material after cooling is pulverized and classified. Typically, average particle diameter of the toner base particles, which is not particularly limited within a range that does not inhibit the purpose of the present disclosure, is preferably 5 to 10 μm.

The method of attaching the external additive to the surface of the toner base particles prepared in this way is not particularly limited and exemplified by a method of mixing the toner base particles and the external additive while adjusting mixing conditions using a mixer such as Henschel mixer and Nauter mixer such that the external additive is not embedded into the toner base particles.

The toner for electrostatic latent image development of the present disclosure described above is excellent in low-temperature fixability, storage stability, and hot offset resistance. Images with excellent glossiness can be formed by virtue of using the toner. Accordingly, the toner for electrostatic latent image development of the present disclosure may be favorably used in various image forming apparatuses.

### EXAMPLES

The present disclosure is explained more specifically with reference to examples below. In addition, the present disclosure is not limited to the examples.

### Example 1

Materials of 87% by mass of a binder resin (polyester resin, HP-313, by Nippon Synthetic Chemical Industry Co.), 3% by mass of a colorant (carbon black, MA-100, by Mitsubishi Chemical Co.), 2% by mass of a charge control agent (N-01, by Orient Chemical Industries Co.), 4% by mass of a charge control agent (FCA-201-PS, by Fujikurakasei Co.), 2% by mass of a natural ester wax (wax with higher melting point (melting point 80° C.), carnauba wax, by Toakasei Co.), and 2% by mass of a synthetic ester wax (wax with lower melting point (melting point 71° C.), WEP-4, by NOF Co.) were mixed by a Henschel mixer (model FM-10, by Mitsui Mining Co.). The resulting mixture was melted and kneaded by a twin screw extruder (TEM-26SS, by Toshiba Machine Co.) to obtain a kneaded material. The resulting kneaded material after cooling was coarsely pulverized by a Rotoplex mill (by Toakikai Co.) into an average diameter of about 2 mm and then finely pulverized by a Turbo mill (RS type, by Turbo Industries, Co.). The finely pulverized product was classified by a wind classifier (model EJ-L-3 (LABO), by Nittetsu Mining Co.) to obtain toner base particles with a volume average particle diameter of 7.0 μm. The volume average particle diameter of the toner base particles was measured by Multisizer 3 (by Beckman Coulter Inc.).

To 100 parts by mass of the resulting toner base particles, 1.5 parts by mass of positively-chargeable silica fine particles (RA200, by Japan Aerosil Co.) and 1.0 part by mass of titanium oxide (MT-500B, by Tayca Co.) were added, then which were subjected to external treatment by mixing at a rotation number of 3500 rpm for 5 minutes using a Henschel mixer (model FM-10, by Mitsui Mining Co.) to obtain a toner of Example 1.

The toner of Example 1 was measured by a differential scanning calorimeter (DSC) in accordance with the processes below to determine the fusion-starting temperature TB, the lower endothermic peak temperature T1, the intermediate endothermic peak temperature T2, and the higher endothermic peak temperature T3. TB, T1, T2, and T3 of the toner of Example 1 are shown in Table 1. Furthermore, a chart resulting from DSC measurement of the toner of Example 1 is shown in FIG. 1.

### Process of Measuring Differential Scanning Calorie

DSC6200 (by Seiko Instruments Inc.) was used for the differential scanning calorimeter (DSC). A toner sample was heated from 30° C. to 170° C. at a rate of 10° C./min. Then, the toner sample was cooled to 30° C. at a rate of 10° C./min. In addition, the toner sample was re-heated from 30° C. to 170° C. at a rate of 10° C./min, thereby measuring by the differential scanning calorimeter. Here, amount of the toner sample was 10 mg. Based on a DSC curve resulting from measurement at the time of re-heating, TB, T1, T2, and T3 were determined. Initially, a temperature at an intersection between a base line observed at the side higher than the higher endothermic peak temperature T3 and a downward curve observed at the side lower than the lower endothermic peak temperature T1 was determined as TB (° C.). Next, three peak temperatures observed in series after starting the measurement were determined as T1 (° C.), T2 (° C.), and T3 (° C.) from the side of lower peak temperature.

Furthermore, the toner of Example 1 was evaluated with respect to the low-temperature fixability, the hot offset resistance, the heat-resistant storage stability, the image glossiness, and the dispersibility of release agent (wax) in accordance with the processes below.

### Process of Evaluating Low-Temperature Fixability

### (Preparation of Two-Component Developer)

Ten parts by mass of the toner of Example 1 was compounded with 100 parts by mass of a carrier used in a color printer (FS-05016, by Kyocera Mita Co.) and was sealed into a plastic bottle, then the plastic bottle was rotated at a rotation number of 100 rpm for 30 minutes by a ball mill (by Kyocera Mita Co.) to uniformly mix the carrier and the toner in the plastic bottle, thereby obtaining a two-component developer of Example 1.

The resulting two-component developer was filled into a black developing unit of the color printer (FS-05016, by Kyocera Mita Co.), and the resulting toner was filled into a black toner container. Using the color printer without a fixing unit, a toner image (patch sample) of 2 cm by 3 cm was output as an unfixed image on an evaluation paper (Color Copy 90, by Neusiedler Co.) in a toner mounting amount of 1.8 mg/cm². Then, the unfixed image of patch sample was fixed at a linear velocity of 100 mm/sec and a fixing temperature of 150° C. using the fixing unit of the color printer as a fixing tool. Next, an image area of the resulting fixed image was once folded into double followed by opening, then a weight wrapped around by a fabric and having a mass of 1 kg was reciprocated 5 times on the fold to friction the fold. After the friction, the fold of the sample image was observed, and a peeled length of the image on the fold was measured to evaluate the low-temperature fixability. Criteria of the low-temperature fixability were as follows:

Good: peeled length of the image was shorter than 1 mm; and

Bad: peeled length of the image was 1 mm or longer.

### <Hot Offset Resistance>

Using the developing unit and the toner container the same as those used for the process of measuring the low-temperature fixability and also using the color printer without a fixing unit, a toner image (patch sample) of 2 cm by 3 cm was output as an unfixed image on an evaluation paper (Color Copy 90, by Neusiedler Co.) in a toner mounting amount of 1.8 mg/cm². Then, the unfixed image of patch sample was fixed at a linear velocity of 100 mm/sec and a fixing temperature of 200° C. using the fixing unit of the color printer as a fixing tool. Using the fixed image, occurrence of hot offset was visually evaluated. Criteria of the hot offset resistance were as follows:

Good: no occurrence of hot offset; and

Bad: occurrence of hot offset.

### Process of Evaluating Heat-Resistant Storage Stability

Ten grams of a toner was weighed into a sample bottle made of glass, and the sample bottle containing the toner was allowed to stand under a non-stoppered condition in a constant-temperature oven (DKN602, by Yamato Scientific Co.) at 50° C. for 100 hours. Then, a 26-mesh screen with a known mass was installed on a powder tester (TYPE PT-E 84810, by Hosokawa Micron Co.), the toner after the hot standing was placed on the screen, and the toner was screened for 20 seconds under a condition of rheostat 2.5. Next, the mass of the toner remaining on the screen was measured, and the heat-resistant storage stability was evaluated based on the mass of the toner on the screen after the screening. Criteria of the heat-resistant storage stability were as follows:

Good: toner remaining on the screen was 0.2 g or less; and

Bad: toner remaining on the screen was more than 0.2 g.

### Process of Evaluating Image Glossiness

An unfixed image was output under the same condition as that of evaluating the hot offset resistance. Then, the unfixed image was fixed at a linear velocity of 100 mm/sec and a fixing temperature of 190° C. using a fixing tool. The glossiness of the resulting image after the fixing was measured by a gloss checker (IG-331, by Horiba, Ltd.). Criteria of the image glossiness were as follows:

Good: value of the glossiness was 10 or higher and 15 or less; and

Bad: value of the glossiness was less than 10.

### Process of Evaluating Dispersibility of Release Agent

Five grams of a toner was pressed at a pressure of 20 MPa to prepare a columnar pellet having diameter of 4 cm and thickness of 3 mm. A thin piece of thickness 100 μm was cut out from the resulting pellet using a microtome (REM-710 Retoratome, by Yamato Kohki Industrial Co.), then which was used as a sample for observation. The resulting sample for observation was observed using a transmission electron microscope (HF-3300, by Hitachi High-Technologies Co.) at a magnification ratio of 3000 times, and dispersibility of a release agent in the toner was evaluated by visual observation. Criteria of the dispersibility of a release agent were as follows:

Good: agglomerates of the release agent were scarcely seen;

Bad: agglomerates of the release agent were slightly seen; and

Very bad: many agglomerates of the release agent were seen.

### Example 2

The toner of Example 2 was obtained similarly to Example 1 except that the natural ester wax used for a wax with higher melting point was changed from carnauba wax to rice wax (melting point 82° C., by Toakasei Co.). The toner of Example 2 was measured with respect to the differential scanning calorie (DSC) similarly to Example 1 to determine the fusion-starting temperature TB, the lower endothermic peak temperature T1, the intermediate endothermic peak temperature T2, and the higher endothermic peak temperature T3. TB, T1, T2, and T3 of the toner of Example 2 are shown in Table 1. A two-component developer was also prepared using the toner of Example 2 similarly to Example 1. Furthermore, the toner of Example 2 was evaluated with respect to the low-temperature fixability, the hot offset resistance, the heat-resistant storage stability, the image glossiness, and the dispersibility of release agent (wax) similarly to the toner of Example 1. Evaluation results of the toner of Example 2 are shown in Table 1.

### Comparative Example 1

A toner of Comparative Example 1 was obtained similarly to Example 1 except that the carnauba wax as the wax with higher melting point was not used and the content of a synthetic ester wax (WEP-4, by NOF Co.) as the wax with lower melting point in the toner base particles was changed from 2% by mass to 4% by mass. The toner of Comparative Example 1 was measured with respect to the differential scanning calorie (DSC) similarly to Example 1 to determine the fusion-starting temperature TB, the lower endothermic peak temperature T1, the intermediate endothermic peak temperature T2, and the higher endothermic peak temperature T3. TB, T1, T2, and T3 of the toner of Comparative Example 1 are shown in Table 1. A two-component developer was also prepared using the toner of Comparative Example 1 similarly to Example 1. Next, the toner of Comparative Example 1 was evaluated with respect to the low-temperature fixability, the hot offset resistance, the heat-resistant storage stability, the image glossiness, and the dispersibility of release agent (wax) similarly to the toner of Example 1. Evaluation results of the toner of Comparative Example 1 are shown in Table 1.

### Comparative Example 2

A toner of Comparative Example 2 was obtained similarly to Example 1 except that the synthetic ester wax (WEP-4, by NOF Co.) as the wax with lower melting point was not used and the content of the carnauba wax (by Toakasei Co.) as the wax with higher melting point in the toner base particles was changed from 2% by mass to 4% by mass. The toner of Comparative Example 2 was measured with respect to the differential scanning calorie (DSC) similarly to Example 1 to determine the fusion-starting temperature TB, the lower endothermic peak temperature T1, the intermediate endothermic peak temperature T2, and the higher endothermic peak temperature T3. TB, T1, T2, and T3 of the toner of Comparative Example 2 are shown in Table 1. A two-component developer was also prepared using the toner of Comparative Example 2 similarly to Example 1. Next, the toner of Comparative Example 2 was evaluated with respect to the low-temperature fixability, the hot offset resistance, the heat-resistant storage stability, the image glossiness, and the dispersibility of release agent (wax) similarly to the toner of Example 1. Evaluation results of the toner of Comparative Example 2 are shown in Table 1.

### Comparative Example 3

A toner of Comparative Example 3 was obtained similarly to Example 1 except that a paraffin wax (melting point 81° C., HNP-11, by Nippon Seiro Co.) was used in place of the synthetic ester wax (WEP-4, by NOF Co.) as the wax with lower melting point. The toner of Comparative Example 3 was measured with respect to the differential scanning calorie (DSC) similarly to Example 1 to determine the fusion-starting temperature TB, the lower endothermic peak temperature T1, the intermediate endothermic peak temperature T2, and the higher endothermic peak temperature T3. TB, T1, T2, and T3 of the toner of Comparative Example 3 are shown in Table 1. A two-component developer was also prepared using the toner of Comparative Example 3 similarly to Example 1. Next, the toner of Comparative Example 3 was evaluated with respect to the low-temperature fixability, the hot offset resistance, the heat-resistant storage stability, the image glossiness, and the dispersibility of release agent (wax) similarly to the toner of Example 1. Evaluation results of the toner of Comparative Example 3 are shown in Table 1.

### Comparative Example 4

A toner of Comparative Example 4 was obtained similarly to Example 1 except that the carnauba wax as the wax with higher melting point was substituted with a synthetic ester wax (melting point 82° C., WEP-5, by NOF Co.). The toner of Comparative Example 4 was measured with respect to the differential scanning calorie (DSC) similarly to Example 1 to determine the fusion-starting temperature TB, the lower endothermic peak temperature T1, the intermediate endothermic peak temperature T2, and the higher endothermic peak temperature T3. TB, T1, T2, and T3 of the toner of Comparative Example 4 are shown in Table 1. A two-component developer was also prepared using the toner of Comparative Example 4 similarly to Example 1. Next, the toner of Comparative Example 4 was evaluated with respect to the low-temperature fixability, the hot offset resistance, the heat-resistant storage stability, the image glossiness, and the dispersibility of release agent (wax) similarly to the toner of Example 1. Evaluation results of the toner of Comparative Example 4 are shown in Table 1.

### Comparative Example 5

A toner of Comparative Example 5 was obtained similarly to Example 1 except that the synthetic ester wax (WEP-4, by NOF Co.) as the wax with lower melting point was substituted with a synthetic ester wax (melting point 71° C., WEP-2, by NOF Co.). The toner of Comparative Example 5 was measured with respect to the differential scanning calorie (DSC) similarly to Example 1 to determine the fusion-starting temperature TB, the lower endothermic peak temperature T1, the intermediate endothermic peak temperature T2, and the higher endothermic peak temperature T3. TB, T1, T2, and T3 of the toner of Comparative Example 5 are shown in Table 1. A two-component developer was also prepared using the toner of Comparative Example 5 similarly to Example 1. Next, the toner of Comparative Example 5 was evaluated with respect to the low-temperature fixability, the hot offset resistance, the heat-resistant storage stability, the image glossiness, and the dispersibility of release agent (wax) similarly to the toner of Example 1. Evaluation results of the toner of Comparative Example 5 are shown in Table 1.

TABLE 1

| | Example | | Comparative Example | | | | |
|---|---|---|---|---|---|---|---|
| | 1 | 2 | 1 | 2 | 3 | 4 | 5 |
| Content in toner base | | | | | | | |
| particles (% by mass) | | | | | | | |
| Wax with higher | | | | | | | |
| melting point | | | | | | | |
| Carnauba wax | 2 | — | — | 4 | 2 | — | 2 |
| Rice wax | — | 2 | — | — | — | — | — |
| Synthetic ester wax | — | — | — | — | — | 2 | — |
| (WEP-5) | | | | | | | |
| Wax with lower | | | | | | | |
| melting point | | | | | | | |
| Synthetic ester wax | 2 | 2 | 4 | — | — | 2 | — |
| (WEP-4) | | | | | | | |
| Paraffin wax | — | — | — | — | 2 | — | — |
| (HNP-11) | | | | | | | |
| Synthetic ester wax | — | — | — | — | — | — | 2 |
| (WEP-2) | | | | | | | |
| Evaluation of toner | | | | | | | |
| TB (° C.) | 62.0 | 61.7 | 61.5 | 72.0 | 61.0 | 63.5 | 53.0 |
| T1 (° C.) | 68.8 | 68.6 | 69.3 | — | 68.0 | — | 61.0 |
| T2 (° C.) | 76.3 | 75.8 | — | — | — | 74.0 | 69.2 |
| T3 (° C.) | 83.0 | 82.0 | — | 81.0 | 81.3 | — | 81.2 |
| Low-temperature | 0.8/ | 0.9/ | 0.7/ | 1.7/ | 0.8/ | 1.2/ | 0.7/ |
| fixability (mm/ | Good | Good | Good | Bad | Good | Bad | Good |
| determination) | | | | | | | |
| Hot offset resistance | 205/ | 200/ | 190/ | 200/ | 200/ | 195/ | 205/ |
| (° C./determination) | Good | Good | Bad | Good | Good | Bad | Good |
| Heat-resistant storage | 0.10/ | 0.12/ | 0.30/ | 0.13/ | 0.15/ | 0.08/ | 0.60/ |
| stability (g/ | Good | Good | Bad | Good | Good | Good | Bad |
| determination) | | | | | | | |
| Image glossiness | 12/ | 11/ | 7/ | 11/ | 8/ | 7/ | 6/ |
| (glossiness/ | Good | Good | Bad | Good | Bad | Bad | Bad |
| determination) | | | | | | | |
| Dispersibility of wax | Good | Good | Very | Good | Very | Very | Bad |
| | | | bad | | bad | bad | |

It is understood from Examples 1, 2 that when the toner for electrostatic latent image development includes at least a binder resin, a colorant, a charge control agent, and a release agent, in which the release agent contains a synthetic ester wax and a natural ester wax, the fusion-starting temperature TB is 60° C. or higher, the lower endothermic peak temperature T1 derived from one ester wax is 63° C. to 73° C., the intermediate endothermic peak temperature T2 is 73° C. to 80° C., the higher endothermic peak temperature T3 derived from another ester wax is 80° C. to 87° C., and the TB, the T1, the T2 and the T3 are observed during the re-heating, consequently, the low-temperature fixability, the hot offset resistance, and the heat-resistant storage stability thereof are excellent. It is also understood from Examples 1, 2 that when the toners of Examples 1, 2 are used, images with excellent glossiness can be formed.

The toner of Comparative Example 1 contains only the synthetic ester wax (WEP-4, by NOF Co.) as a wax with lower melting point as a release agent and does not contains any wax with higher melting point. Therefore, the toner of Comparative Example 1 is inferior in terms of the heat-resistant storage stability since the content of the wax with lower melting point is larger. Furthermore, the toner of Comparative Example 1 is therefore inferior in terms of the hot offset resistance since it is difficult to take a proper mold release function between fuser rollers and images at higher temperatures. Moreover, the viscosity of the wax with lower melting point becomes extremely low when preparing the toner at the step of melting and kneading, thus it is difficult to highly disperse the wax since shear force is unlikely to act on the wax. Therefore, in the toner of Comparative Example 1, the wax is not properly dispersed in the toner. For this reason, glossiness of images formed from the toner of Comparative Example 1 is low.

In the toner of Comparative Example 2, only the carnauba wax is used as a wax with higher melting point and any wax with lower melting point is not included. Therefore, the toner of Comparative Example 2 is inferior in terms of the low-temperature fixability.

The toner of Comparative Example 3 contains the natural ester wax as a wax with higher melting point, but contains paraffin wax rather than the synthetic ester wax as a wax with lower melting point. Because of such a combination of waxes, two kinds of waxes are not properly mixed and thus the waxes are not properly dispersed in the toner of Comparative Example 3. For this reason, glossiness of images formed from the toner of Comparative Example 3 is low. Here, in the toner of Comparative Example 3, since the two kinds of waxes are not properly mixed, the intermediate endothermic peak is not formed.

The toner of Comparative Example 4 contains a combination of synthetic ester waxes themselves as a wax with higher melting point and a wax with lower melting point. Because of such a combination of waxes, the waxes are not properly dispersed in the toner of Comparative Example 4. For this reason, glossiness of images formed from the toner of Comparative Example 4 is low. Additionally, in the toner of Comparative Example 4, the lower-temperature endothermic peak and the higher-temperature endothermic peak have disappeared. As being understood from the disappearance of the lower-temperature endothermic peak in the toner of Comparative Example 4, the wax with lower melting point is unlikely to dissolve at lower temperatures, thus the low-temperature fixability of the toner of Comparative Example 4 is poor. As being also understood from the disappearance of the higher-temperature endothermic peak, the wax in the toner of Comparative Example 4 is unlikely to dissolve at higher temperatures. For this reason, it is difficult for the toner of Comparative Example 4 to take a proper mold release function between fuser rollers and images at higher temperatures, thus the hot offset resistance is poor.

The toner of Comparative Example 5 contains carnauba wax as a natural ester wax and a synthetic ester wax in combination, therefore, a lower-temperature endothermic peak, an intermediate endothermic peak, and a higher-temperature endothermic peak are observed. However, in the toner of Comparative Example 5, TB is lower than 60° C., thus the heat-resistant storage stability is remarkably poor. Furthermore, the combination of waxes in Comparative Example 5 results in somewhat difficult dispersion of the waxes. For this reason, glossiness of images formed from the toner of Comparative Example 5 is low.

What is claimed is:

1. A toner for electrostatic latent image development, comprising a binder resin, a colorant, a charge control agent, and a release agent, wherein
the release agent contains a synthetic ester wax and a natural ester wax,
when a toner sample is measured by a differential scanning calorimeter in a way that the toner sample is heated from 30° C. to 170° C. at a rate of 10° C./min followed by cooling to 30° C. at a rate of 10° C./min and is then re-heated from 30° C. to 170° C. at a rate of 10° C./min,
a fusion-starting temperature TB is 60° C. or higher,
a lower endothermic peak temperature T1 derived from one ester wax is 63° C. to 73° C.,
an intermediate endothermic peak temperature T2 is 73° C. to 80° C.,
a higher endothermic peak temperature T3 derived from another ester wax is 80° C. to 87° C., and
the TB, the T1, the T2 and the T3 are observed during the re-heating.

2. The toner for electrostatic latent image development according to claim 1, wherein the content of the release agent is 1 to 5 parts by mass based on 100 parts by mass of the binder resin.

3. The toner for electrostatic latent image development according to claim 1, wherein the natural ester wax is carnauba wax or rice wax.

4. The toner for electrostatic latent image development according to claim 1, wherein the mass ratio of the content of the natural ester wax to that of the synthetic ester wax, expressed as (natural ester wax)/(synthetic ester wax), is 3/7 to 7/3.
